(19) United States
(12) Patent Application Publication
(10) Pub. No.: US 2007/0223243 A1
(43) Pub. Date: Sep. 27, 2007

(54) Lighting system for a recreational vehicle

(75) Inventors: Todd W. Yeoman, Osceola, IN (US); Gregory A. Neff, Granger, IN (US)

Correspondence Address: BARNES & THORNBURG LLP, P.O. BOX 2786, CHICAGO, IL, 60690-2786, US

(73) Assignee: American Technology Components, Incorporated

(21) Appl. No.: 11/389,905

(22) Filed: Mar. 27, 2006

(51) Int. Cl. F21S 8/10

(52) U.S. Cl. 362/545

(57) ABSTRACT

A lighting system for a recreational vehicle comprising a puck light or other in-vehicle light and a light switch. The puck light includes a plurality of first light emitting diodes and a night light in the form of at least one second light emitting diode. The light switch has a first switch position in which the first light emitting diodes and the second light emitting diode are “off,” a second switch position in which the first light emitting diodes are “on” and the second light emitting diode is “off,” and a third position in which the first light emitting diodes are “off” and the second light emitting diode is “on.” The first light emitting diodes may be positioned in a circular array surrounding the second light emitting diode. The light switch may be secured to a wall or other surface of the recreational vehicle.

The present disclosure relates to a lighting system for a recreational vehicle, such as, for example, an RV vehicle or a boat or the like.

### BACKGROUND

“Puck lights” are well known in the recreational vehicle industry for illuminating an area of a recreational vehicle. Puck lights typically are circular and relatively flat and can be mounted, for example, on ceilings, underneath cabinets and on other surfaces of a recreational vehicle. Puck lights may utilize different types of lights, including, for example, light emitting diodes which tend to provide efficiency and other important advantages.

### SUMMARY

The present disclosure relates to a lighting system for a recreational vehicle comprising an in-vehicle puck light or other in-vehicle light and a 3-position light switch. The puck light includes a plurality of first light emitting diodes and a night light in the form of at least one second light emitting diode. The light switch has a first switch position in which the first light emitting diodes and the second light emitting diode are “off,” a second switch position in which the first light emitting diodes are “on” and the second light emitting diode is “off,” and a third position in which the first light emitting diodes are “off” and the second light emitting diode is “on.” The first light emitting diodes may be positioned in a circular array surrounding the second light emitting diode. The puck light may be secured on a ceiling, underneath a cabinet, or on any other surface of the recreational vehicle. The light switch may be secured to a wall or other surface of the recreational vehicle.

Additional features of the present disclosure will become apparent to those skilled in the art upon consideration of the following detailed description of illustrative embodiments of the disclosure.

### BRIEF DESCRIPTION OF THE DRAWINGS

The detailed description particularly refers to the accompanying figure in which:

FIG. 1 is a broken partial perspective view of a lighting system for a recreational vehicle in accordance with an embodiment of the present disclosure, including a light positioned underneath a cabinet of a recreational vehicle and a light switch positioned on a wall of the recreational vehicle; and

FIG. 2 is a perspective view of the light of FIG. 1.

### DETAILED DESCRIPTION

While the present disclosure may be susceptible to embodiment in different forms, there is shown in the drawings and herein will be described in detail, embodiments with the understanding that the present description is to be considered an exemplification of the principles of the disclosure and is not intended to limit the disclosure to the details of construction and the number and arrangements of components set forth in the following.

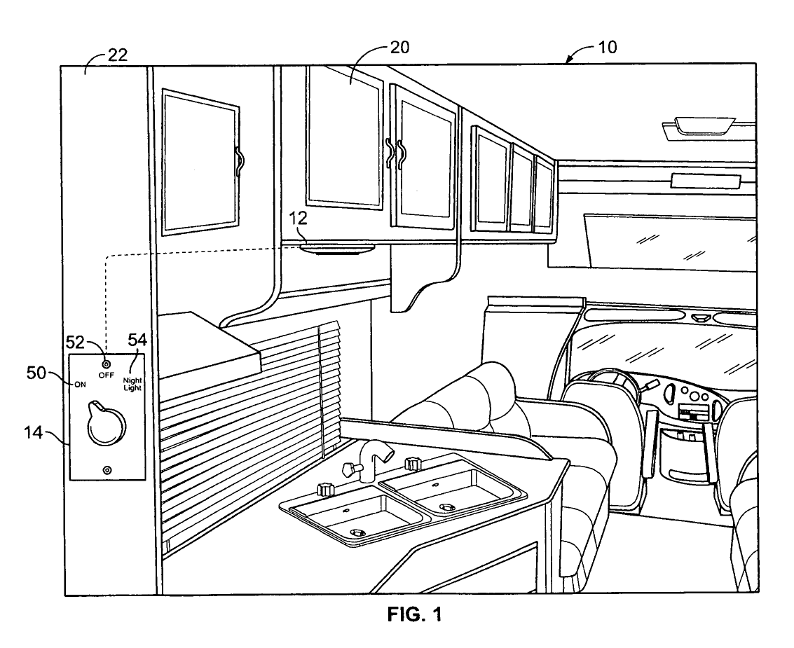

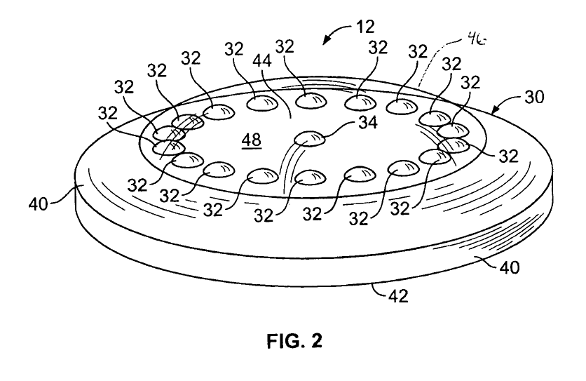

FIGS. 1-2 illustrate a lighting system in accordance with an illustrative embodiment of the present disclosure for a recreational vehicle 10 in the form of an RV. The illustrated lighting system comprises an in-vehicle light 12 and a light switch 14. The in-vehicle light 12 is positioned or otherwise disposed underneath a cabinet 20 of the recreational vehicle 10, and the light switch 14 is positioned or otherwise disposed on a wall 22 of the recreational vehicle. The in-vehicle light 12 and the light switch 14 may be disposed anywhere else relative to the recreational vehicle 10 in accordance with other embodiments of the present disclosure. Additionally, the recreational vehicle 10, the in-vehicle light 12, and the light switch 14 may be in any other suitable form and have any other suitable construction in accordance with other embodiments of the present disclosure.

The illustrated in-vehicle light 12 is in the form of a puck light comprising a circular housing 30 and a plurality of light emitting diodes disposed within the housing. The light emitting diodes include a plurality of first light emitting diodes 32 which extend in a circular array and a second light emitting diode 34 surrounded by the circular array of first light emitting diodes. The first light emitting diodes 32 are a light source for lighting the area underneath the cabinet 20. The second light emitting diode 34 is a night light. The housing 30 of the in-vehicle light 12 includes a circular frame 40, a mounting base 42 for mounting to the cabinet 20 by any suitable means, light emitting diode module 44 disposed and housed between the circular frame and the mounting base, and a transparent cover 46 extending over the light emitting diode module 44.

The first light emitting diodes 32 and the second light emitting diode 34 are mounted to a face 48 of the light emitting diode module 44. The second light emitting diode 34 may be mounted to the center of the upper face 48 of the light emitting diode module 44 so that the second light emitting diode, the circular array of the first light emitting diodes 32 and the housing 30 are generally concentric. The in-vehicle light 12 may have any other suitable construction in accordance with other embodiments of the present disclosure. The in-vehicle light 12 may, for example, have a construction similar to the light emitting diode puck light disclosed in U.S. Pat. No. 6,641,283 which is incorporated herein in its entirety by reference.

The illustrated light switch 14 is in the form of a 3-position control switch movable to three different switch positions. In the first switch position 50, the first light emitting diodes 32 and the second light emitting diode 34 are not illuminated and thus are “off”. In the second switch position 52, the first light emitting diodes 32 are illuminated and thus “on” and the second light emitting diode 34 is “off.” In the third switch position 54, the second light emitting diode 34 is “on” and the first light emitting diodes 32 are “off.” The first, second and third switch positions 50, 52 and 54 are marked on the illustrated light switch 14 as “On”, “Off” and “Night Light”, respectively. The light switch 14 may have any other suitable markings, if any, and any other suitable construction and may be positioned anywhere else relative to the recreational vehicle 10 and in-vehicle light 12 in accordance with other embodiments of the present disclosure.

The in-vehicle light 12 and the light switch 14 may be constructed of any suitable electrical and other components and may be electrically connected to each other in any suitable manner. By way of example, the in-vehicle light 12 may be a 12V light, and the first light emitting diodes 32 and second light emitting diodes 34 may be standard white or colored light emitting diodes. Components of the housing 30 such as the circular frame 40, the mounting base 42, the light emitting diode module 44, and the cover 46 and components of the light switch 14 may be constructed of any suitable plastic material or any other suitable material.

A lighting system in accordance with the illustrated embodiment of the present disclosure may be utilized as follows. When the light switch 14 is in the first switch position 50, the first light emitting diodes 32 and the second light emitting diode 34 are “off.” The first switch position 50 may be utilized when neither a light source nor a night light is desired. When the light switch 14 is in the second switch position 52, the first light emitting diodes 32 are “on” and the second light emitting diode 34 is “off.” The second switch position 52 may be utilized when a light source is needed underneath the cabinet 20. When the light switch 14 is in the third switch position 54, the first light emitting diodes 32 are “off” and the second light emitting diode 34 is “on.” The third switch position 54 may be utilized when a night light is desired but a light source is not desired.

The foregoing description is for exemplary purposes only and is not intended to limit the scope of protection accorded this disclosure. The scope of protection is to be measured by the following claims, which should be interpreted as broadly as the contribution permits.

1. A light system for a recreational vehicle comprising (a) an in-vehicle light including a plurality of first light emitting diodes and at least one second light emitting diode; and (b) a 3-position light switch having a first position in which neither the first light emitting diodes nor the second light emitting diode are illuminated, a second position in which the first light emitting diodes are illuminated and the second light emitting diode is not illuminated, and a third position in which the first light emitting diodes are not illuminated and the second light emitting diode is illuminated.

2. The light system of claim 1 wherein the in-vehicle light comprises a circular housing, the first and second light emitting diodes are disposed within the housing.

3. The light system of claim 1 wherein the first light emitting diodes surround the second light emitting diode.

4. The light system of claim 1 wherein the first light emitting diodes extend in a circular array surrounding the second light emitting diode.

5. The light system of claim 1 wherein the in-vehicle light includes a circular housing and wherein the first light emitting diodes extend in a circular array around the second light emitting diode, the circular housing, the circular array of the first light emitting diodes and the second light emitting diode being concentric.

6. The light system of claim 1 wherein the first light emitting diodes light are configured to illuminate a portion of an inside area of the recreational vehicle and the second light emitting diode is a night light.

7. The light system of claim 1 wherein the light switch is positioned apart from the in-vehicle light.

8. The light system of claim 1 wherein the in-vehicle light comprises a puck light.

9. The light system of claim 1 wherein the light switch is configured to be secured to the recreational vehicle.

10. A recreational vehicle comprising (a) an in-vehicle light disposed in an inside area of the recreational vehicle including a plurality of first light emitting diodes for lighting the inside area and a night light including at least one second light emitting diode; and (b) a 3-position light switch disposed on a surface of the recreational vehicle, the light switch having: (i) a first position in which neither the first light emitting diodes nor the second light emitting diode are illuminated; (ii) a second position in which the first light emitting diodes are illuminated and the second light emitting diode is not illuminated; and (iii) a third position in which the second light emitting diode is illuminated and the first light emitting diodes are not illuminated.

11. The recreational vehicle of claim 10 wherein the in-vehicle light includes a circular housing.

12. The recreational vehicle of claim 10 wherein the first light emitting diodes surround the second light emitting diode.

13. The recreational vehicle of claim 10 wherein the first light emitting diodes extend in a circular array surrounding the second light emitting diode.

14. The recreational vehicle of claim 10 wherein the in-vehicle light includes a circular housing and wherein the first light emitting diodes extend in a circular array surrounding the second light emitting diode, the circular housing, the circular array of the first light emitting diodes and the second light emitting diode being concentric.

15. The recreational vehicle of claim 10 wherein the first light emitting diodes light are configured to illuminate a portion of an inside area of the recreational vehicle and the second light emitting diode is a night light.

16. The recreational vehicle of claim 10 wherein the light switch is positioned apart from in-vehicle light.

17. A recreational vehicle comprising (a) a puck light disposed in an inside area of the recreational vehicle, the in-vehicle light comprising a circular housing, a plurality of first light emitting diodes disposed within the circular housing for lighting the inside area and a night light including at least one second light emitting diode disposed within the circular housing; and (b) a light switch disposed on a surface of the recreational vehicle having: (i) a first position in which neither the first light emitting diodes nor the second light emitting diode are illuminated; (ii) a second position in which the first light emitting diodes are illuminated and the second light emitting diode is not illuminated; and (iii) a third position in which the second light emitting diode is illuminated and the first light emitting diodes are not illuminated.

18. The recreational vehicle of claim 17 wherein the first light emitting diodes extend in a circular array surrounding the second light emitting diode.

19. The recreational vehicle of claim 18 wherein the circular housing, the circular array of the first light emitting diodes and the second light emitting diode are concentric.

20. The recreational vehicle of claim 17 where the second light emitting diode comprises a night light.
